(19) United States
(12) Patent Application Publication
(10) Pub. No.: US 2017/0046760 A1
(43) Pub. Date: Feb. 16, 2017

(54) PROVIDER SEARCH SYSTEMS AND METHODS

(71) Applicant: William B. Kurtz, Nashville, TN (US)

(72) Inventor: William B. Kurtz, Nashville, TN (US)

(21) Appl. No.: 15/232,943

(22) Filed: Aug. 10, 2016

Related U.S. Application Data
(60) Provisional application No. 62/203,025, filed on Aug. 10, 2015.

(51) Int. Cl. G06Q 30/06; G06Q 30/02; G06Q 50/22; G06Q 50/00

(52) U.S. Cl. CPC G06Q 30/0623; G06Q 50/01; G06Q 30/0282; G06Q 50/22

(57) ABSTRACT

Systems, devices and methods for utilizing social-networking data, including relationship data from one or more social-networking databases, to improve sharing of information and establishing contacts between individuals, including improvements in the actual and/or perceived reliability of performance reviews and recounted past experiences from past consumers of products and/or services, including among patients regarding specific medical providers.

### CROSS-REFERENCE TO RELATED APPLICATIONS

This application claims the benefit of U.S. Provisional Patent Application Ser. No. 62/203,025 entitled “Provider Search and Ratings Application,” filed Aug. 10, 2015, the disclosure of which is incorporated by reference herein in its entirety.

### TECHNICAL FIELD

The invention relates to devices, systems, software and related business methods for sharing information among individuals regarding their ratings or past experiences with third party providers of goods and/or services, such as specific medical providers.

### BACKGROUND OF THE INVENTION

Multiple web based physician rating sites exist where patients can write reviews about their experiences with their physicians. However, patients are often reluctant to utilize web based ratings agencies in part because they don't trust the data and/or the data provider. In many instances, the data is perceived as potentially biased by the rating agency accepting payments from the providers or the data could just be inaccurate or irrelevant. In other cases a data provider could be maliciously writing positive or negative provider reviews and may never have even seen the provider that they were write reviews about. In addition, the patient is not privy to how the ratings are calculated and whether the ratings have a meaningful purpose in their pursuit of healthcare. For example, the reviewers are typically not categorized as patient who had clinic visits vs. surgical treatment, or just ordinary observers. There is no way to know using existing systems that the reviewer is really a patient and has seen the provider in question. Accordingly, many existing rating sites have or are perceived to have significant volunteer bias, where the data provided is self volunteered so only the truly pleased and/or displeased patients take the time to fill out these online forms.

When a patient desires to obtain information on a provider, they typically do not query their remote friends or acquaintances about that provider (or any related providers), unless they know that their friends have seen that same physician as well. Unfortunately, current medical privacy concerns limit and/or prohibit dissemination of personally-identifiable healthcare information, and people are often hesitant to disclose their personal healthcare experiences to the general public. Accordingly, there does not currently exist an easy and reliable way for a patient to determine anonymously if any of their friends or acquaintances has ever seen or had an experience with the physician in question.

### BRIEF SUMMARY OF THE INVENTION

The present invention includes the realization of the need for a filtered, blinded and/or anonymous matching system for individuals having experienced healthcare services or other goods and/or services from a third party seller, such as a healthcare provider, and other individuals who are planning on obtaining similar goods and/or services (such as receiving healthcare services) from the same or similar third party seller such as a healthcare provider (for themselves or on behalf of someone else). In various embodiments, the disclosed system can include a preferred ratings agency model that anonymously (or using partially blinded and/or filtered contact methods) identifies linkages between past and prospective customers or patients, and connects a prospective consumer or patient with one of their friends or acquaintances that has already purchased the good or service or already seen that healthcare provider, while still protecting the two peoples' identity to whatever degree each of the parties want their individual identities protected.

In one exemplary embodiment, the system might include a database that identifies patient A having a relationship with physician A. When Patient B is looking for a new physician, the system allows Patient B to query information about Physician A (as well as one or more other physicians who may have locations and/or practices similar to Physician A's), which can include queries about general information on the physician as well as specific information relating to specific topics (which may include questions and related sub-questions about physician A). The system can also include a dataset identifying that Patient B and Patient A know each other, or the system can perform various methods of obtaining such relationship data (i.e., create a social or relationship graph or map) before, during and/or after the Patient B query about Physician A is received—i.e., the patients each have each other in their contacts list on their phone, or they “like” each other on Facebook, or they have mutual acquaintances (which could include mutual acquaintances identified across a plurality of third-party websites such as one relationship link from FaceBook and a second relationship link from LinkedIn, etc.) Once the system identifies an appropriate relationship, it can initiate contact between the two individuals in a variety of ways, even though Patient B does not know that Patient A has ever seen physician A. Once contact is initiated, such contact can be conducted anonymously, if desired, or the system can identify the parties and enable patient B to directly call/contact patient A and asked patient A about their experience with physician A.

Various embodiments include unique ways for a system and related software applications to gather ratings by current or former patients on a physician through a patient engagement portal/application and report those ratings to a prospective patient. If desired, the prospective patient could see all ratings anonymously, and/or may also see which ratings belonged to former patients that also appeared in the prospective patient's contact list on their smart phone (i.e., acquaintances). In various embodiments, a prospective patient could then reveal their identity through the portal/application to an identified/anonymous acquaintance and request that the acquaintance reveal their identity to the prospective patient. If both parties revealed their identity, then the two parties could then have a conversation, email or text message about the physician in question. The parties could also agree to share text messages or other content without sharing their identity.

The physician search application could also validate or share basic descriptive facts about the former patient who was providing the review. For instance, the reviews by patients that had a certain procedure performed by physician A could be grouped accordingly. The application could show 195 reviews for physician A (average 4.6 stars out of 5) with 45 reviews from patients that had a knee replacement by physician A (average 4.8 stars) and 25 reviews from patients that had a hip replacement by physician A (average 4.3 stars). Of the 45 reviews from patients that had a knee replacement, 4 of those reviews came from patients that also appear on the searcher's contact list in their smart phone.

### BRIEF DESCRIPTION OF THE SEVERAL VIEWS OF THE DRAWINGS

The foregoing and other objects, aspects, features, and advantages of embodiments will become more apparent and may be better understood by referring to the following description, taken in conjunction with the accompanying drawings. The term smart phone refers to any portable electronic device, tablet, web-based program or computer of any type. The term app or application refers to a software program and related computing hardware and could mean any computer code running on an electronic device or computer.

FIGS. 1a and 1b depict exemplary embodiments of a patient interface of the present system, such interfaces appearing on a patient's smart phone with a pop up message that inquires about the patient's recent medical treatment;

FIGS. 2a, 2b, 2c, and 2d depict other exemplary embodiments of a patient interface of the present system, such interfaces appearing on a patient's smart phone where the prospective patient might review physicians' ratings provided by former patients and request to communicate with former patients that appeared in the prospective patient's contact list on their smart phone or similar program that links users that know each other (i.e. acquaintance);

FIGS. 3a and 3b depict other exemplary embodiments of a patient interface of the present system, such interfaces appearing on an identified acquaintance's smart phone. where the prospective patient has requested to communicate with the acquaintance, and the acquaintance can decide to release their identity, communicate without releasing their identity, or not communicate at all; and

FIGS. 4a and 4b depict other exemplary embodiments of a patient interface of the present system, such interfaces appearing on an identified prospective patient's smart phone, where the acquaintance has revealed some or all of their identity and the prospective patient can start to communicate with the acquaintance.

### DETAILED DESCRIPTION OF THE INVENTION

Generally, in terms of hardware architecture, various components of the system can include software programs resident upon computers and/or computing devices (including mobile computing devices) which include a processor, memory, and one or more input and/or output (I/O) devices (or peripherals) that are communicatively coupled via a local interface. The local interface may be, for example, but is not limited to, one or more buses or other wired or wireless connections, as is known in the art. A local interface may have additional elements, which are omitted for simplicity, such as controllers, buffers (caches), drivers, repeaters, and receivers, to enable communications. Further, the local interface may include address, control, and/or data connections to enable appropriate communications among the other computer components.

The processor can be a hardware device for executing software, particularly software stored in memory. Processor can be any custom made or commercially available processor, a central processing unit (CPU), an auxiliary processor among several processors associated with the computer, a semiconductor based microprocessor (in the form of a microchip or chip set), another type of microprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. The processor may also represent a distributed processing architecture such as, but not limited to, SQL, Smalltalk, APL, KLisp, Snobol, Developer 200, MUMPS/Magic.

Memory can include any one or a combination of volatile memory elements (e.g., random access memory—RAM, such as DRAM, SRAM, SDRAM, etc.) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor.

The software in memory may include one or more separate programs. The separate programs can comprise ordered listings of executable instructions for implementing logical functions. In various embodiments, the software in memory can include a local interface on a smart phone or other mobile computing device in accordance with the present invention, including a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers, portable phones and smart phones, tablet computers and/or personal digital assistants (PDAs) (e.g., PalmOS available from Palm Computing, Inc., Android, iPhone OS or iOS, and Windows CE available from Microsoft Corporation). The operating system can essentially control the execution of other computer programs, such as the local interface on a mobile computing device and/or a server-based system for obtaining relationship link data, and can provide scheduling, input-output control, file and data management, memory management, and communication control and related services.

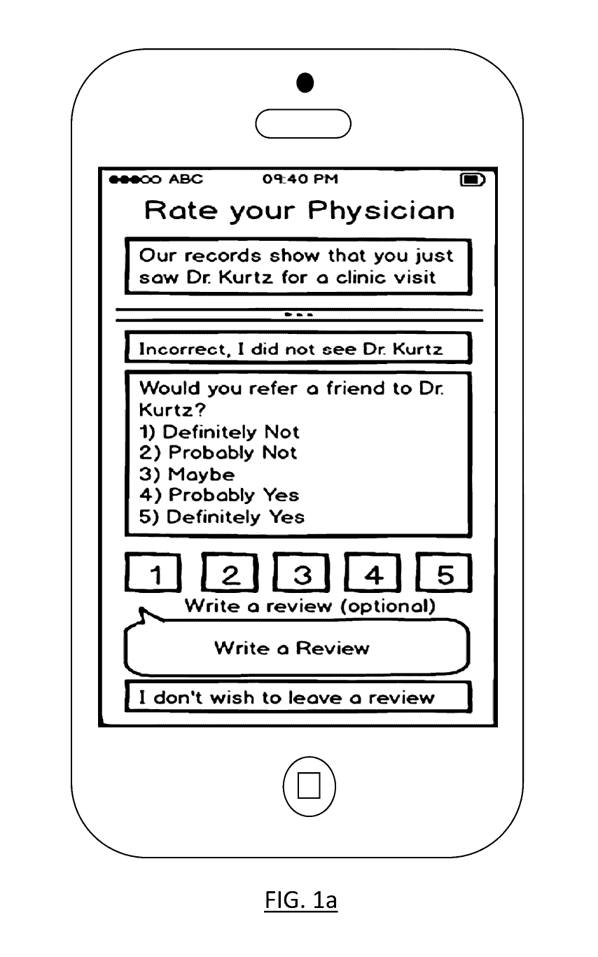

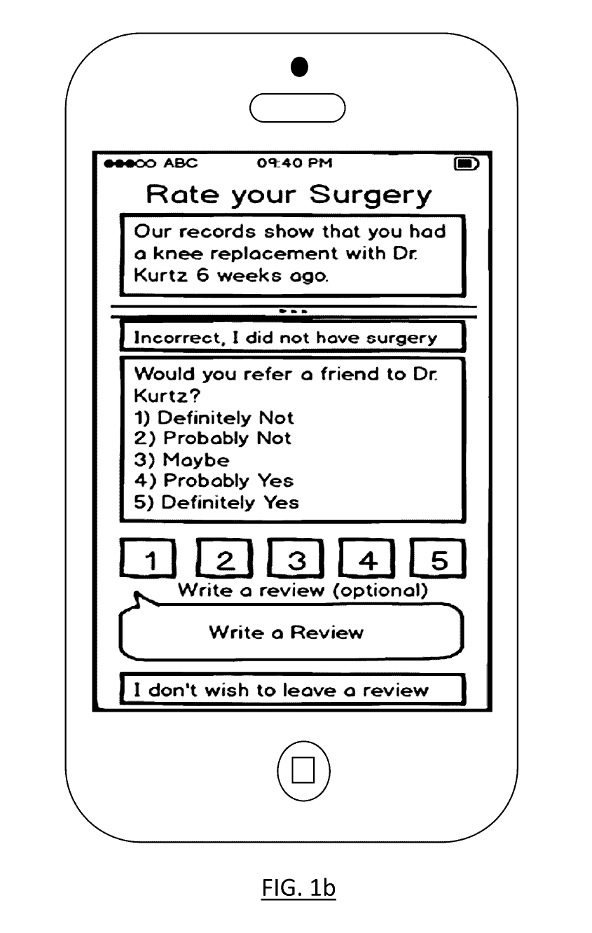

FIGS. 1a and 1b depict exemplary embodiments of a patient interface for use with the present system, wherein a software application (app) resident on a patient's smart phone includes a pop up message that is delivered to the patient after their experience with a provider. This message can inquire about the patient's recent experience with a provider or facility. Since this app could have been used to help schedule the patient's doctor visits, the system could include data reflective of the fact that the patient had received medical services from a physician. The app could access this data and prompt the patient to rate their recent clinic visit with many different questions (FIG. 1a). Since the app could help schedule the patient's surgery, the app could know when the patient had an operation. The app could prompt the patient to rate their surgical experience at multiple different time points after the surgery (FIG. 1b). Patients could be given the option of writing a review as well. Because every patient could be given an opportunity to give a review, much of the volunteer bias that typically occurs with self-reported web sites could be avoided and/or mitigated. Because reviews in the present system might only come from patients after they have scheduled an appointment, the provider ratings would be unlikely and/or impossible to be artificially modified (and/or inflated/deflated) by individuals maliciously posing as real patients.

In contrast to the customer or patient self reported review described in FIG. 1, the app could obtain the customer's or patient's name and purchase of goods or services from the third party seller's customer relationship management database or the healthcare provider's electronic health record. The customer or patient's name, purchased good or service, and business's name could be recorded for a later cross referencing with a prospective customer's or patient's social network or social graph.

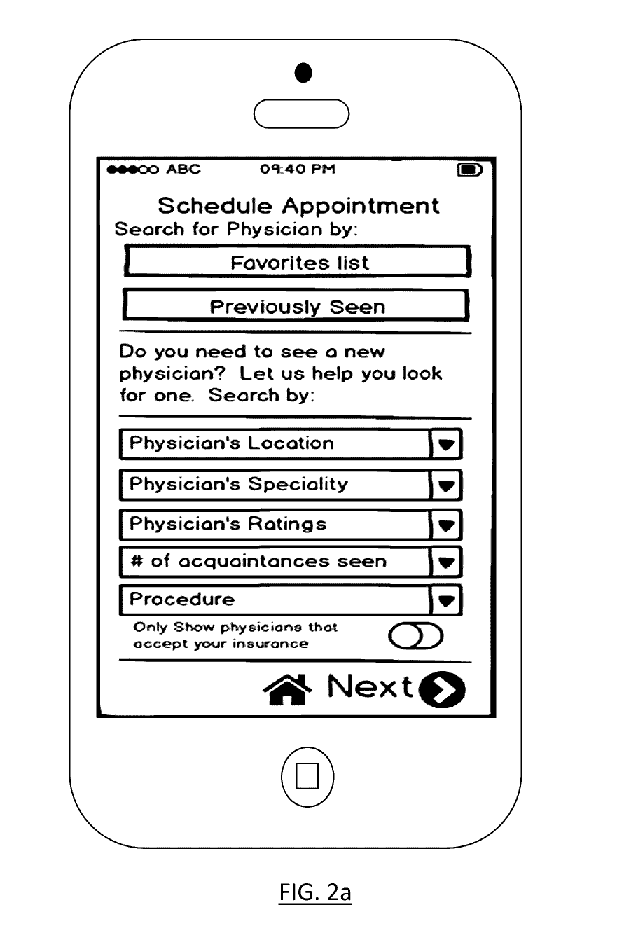

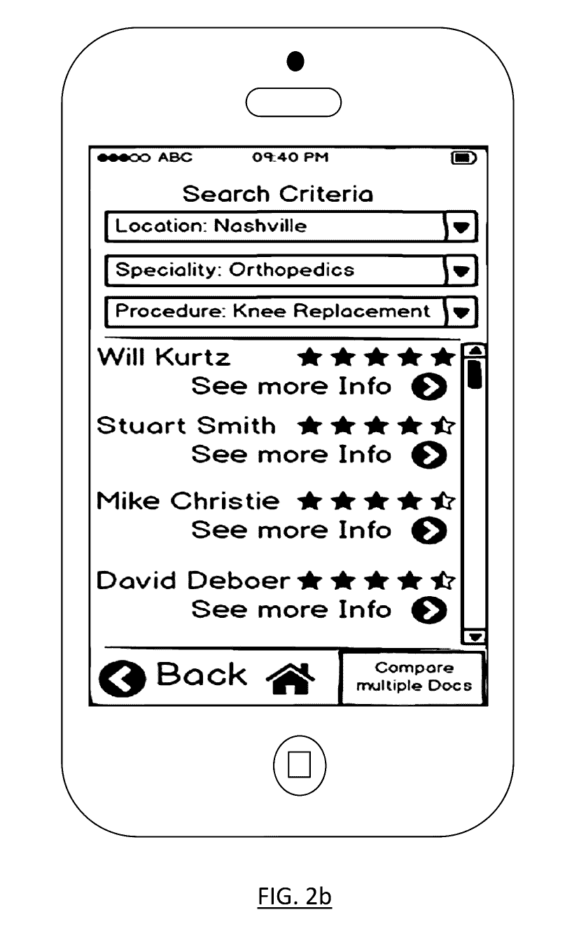

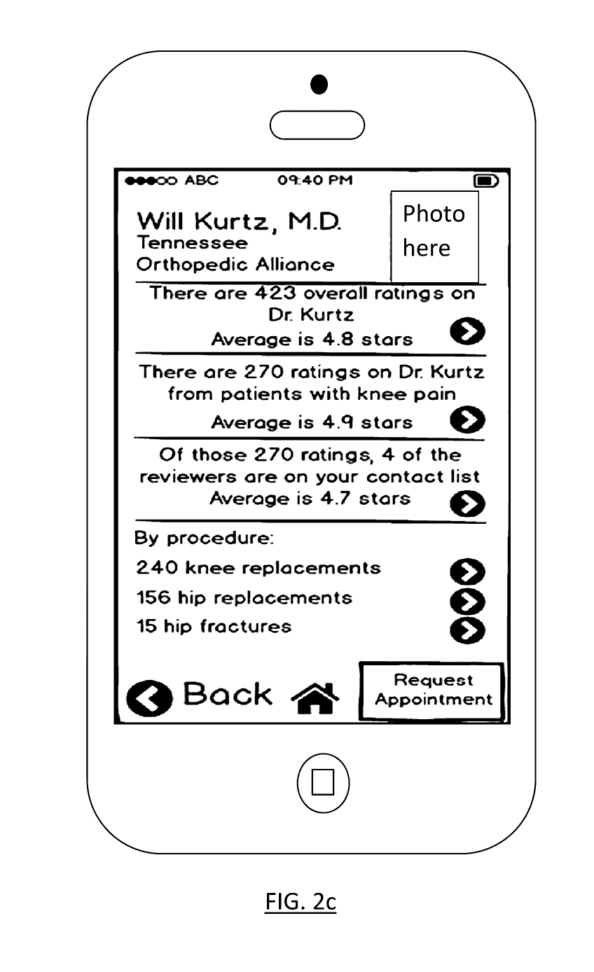

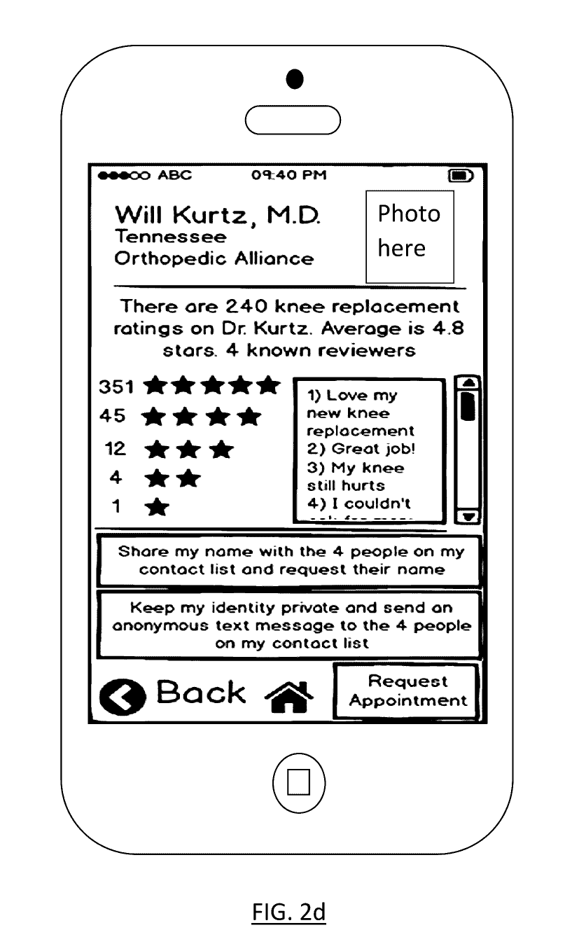

FIGS. 2a, 2b, 2c, and 2d depict exemplary embodiments of a customer′ or patient interface for use with the present system, wherein an app resident on a prospective customer's or patient's smart phone provides an input interface for the prospective customer or patient to review the business's or physicians' ratings and request to communicate with former customers or patients that they might know.

FIG. 2a specifically depicts an interface on a prospective patient's smart phone, including various exemplary search criteria listed. The prospective patient can search for a physician through multiple different search criteria and rank the importance of each criterion. The patient can search by the physician's location (within 50 miles, or by city), by a particular specialty (orthopedics, etc.), by the physician's ratings (only 4 stars or greater), by the number of their acquaintances that had seen that physician, or by the number of procedures that provider had preformed (only surgeons that had done >50 knee replacements in the past year).

FIG. 2b specifically depicts an interface on a prospective patient's smart phone, wherein an app resident on a prospective patient's smart phone provides the prospective patient with a list of physicians who met the prospective patient's search criteria. The patient could change their search criteria as well. The patient could see some general ratings on the physicians on the list or click on the arrow to see more detailed ratings shown in FIG. 2c.

FIG. 2c specifically depicts an interface on a prospective patient's smart phone, wherein an app resident on a prospective patient's smart phone has received search criteria and selected a more detailed view of one physician. The ratings could be displayed to a prospective patient with the reviewers' names omitted and/or obscured/scrambled. The reviewers' names could be cross referenced with the prospective patient's contact list on their smart phone or other social media site, like Facebook, in an attempt to connect two potential patients regarding one's knowledge about a particular provider and another patient's desire to receive a personalized review about that particular provider. When patient B reviewed the ratings on physician A, they could see “there are 423 ratings for physician A with the average score of 4.8 stars; 270 ratings came from patients who presented to physician A with the complaint of knee pain with a score of 4.9 stars, 4 ratings came from your friends or acquaintances with a score of 4.7 stars.” The app could define an acquaintance as someone who appeared in the other party's contact list or only when both parties appeared in each other's contact list. The app could then ask the prospective patient if the app could disclose the prospective patient's name to these “acquaintances” and ask the acquaintance if they were willing to disclose their name to the prospective patient. Presumably, the 4 patients could likely know the prospective patient since their contact information was stored on the prospective patient's phone and possibly vice versa. The four patients that were selected as acquaintances could reveal or not reveal their identity to the prospective patient. The acquaintances could also agree to engage in an anonymous text messaging. In various additional embodiments is may be desirable for the system and methods to be capable of determining and/or finding acquaintances and/or relationships for an individual without the requirements for prior and/or contemporary reviews of third party goods and/or services.

In various embodiments, the system could include devices and/or software capable of “web-crawling” or data mining multiple third-party websites and/or databases for relationship data, and the collecting and/or collating of such obtained data to identify relationships not found in either database individually. For example, Patient A and Patient B may not have a direct relationship accessible from any individual dataset, but Patient A may have a relationship with a third party “Z” on FaceBook, while Patient B has a relationship with third party “Z” on LinkedIn. The system would desirably have the capability to obtain and/or identify relationship data from both third-party websites (i.e., both FaceBook and LinkedIn), subsequently creating a “relationship linkage map” between patient A and patient B, and possibly presenting some of all of this relationship linkage data to one or more of the patients (which may include identification of the sources of the specific linkages in the chain) for potential use with the various features described herein. If desired, the system could include a user-defined feature that identifies the number of intermediate linkages in a relationship linkage chain, and which may prioritize various linkages based on user-input data (i.e., family acquaintances versus friends, how often a friend in a linkage is contacted via a website or email, number of links in the linkage chain, etc.) In various embodiments, the system may include algorithms or other processes that can analyze relationships between individuals, and which may even estimate the probability of a relationship for individuals not having a directly definable linkage (i.e., the two individuals are not directly linked by any third parties, but the two individuals have so many relationships in common that the system can infer that a relationship between the two individuals is likely to exist).

The various databases described herein could maintain relevant information, inter alia, electronic patient information and/or relationship information, including demographic information. As one of ordinary skill in the art would appreciate, databases may be any type of mass storage device or storage medium, such as, for example, magnetic hard disks, floppy disks, cloud storage, optical disks (e.g., CD-ROMs), flash memory, DRAM, and may also include a collection of devices (e.g., Redundant Array of Independent Disks (“RAID”)). It should similarly be understood that databases and related servers could reside on the same computing device or on different computing devices in communication with each other. In a preferred embodiment, a patient review database can is organized as a relational database (e.g., user-specific mapping to a medical concept, physician, physician practice and/or review); although it should be understood that other hierarchical- and network-based database models may be used.

One or more provider servers could be accessible over a data network through network connection. Data network may be any one of a global data network (e.g., the Internet), a regional data network, or a local area network. Network connection desirably would support both wired and wireless data communication and include high-speed Ethernet devices. Network connections are implemented using any known high-level protocols, such as TCP/IP and may comprise multiple networks of differing protocols connected through appropriate gateways.

In one embodiment, provider server can also host and provide access to several Web pages. Patient reviews, relationship data and/or physician information—such as the data stored in one or more databases—could be exchanged and viewed through Web pages. Each Web page can be identifiable via unique Uniform Resource Locators (“URL”) and accessible using common networking protocol (e.g., HyperText Transfer Protocol (“HTTP”), HTTP Secure (“HTTPS”), Transport Layer Security (“TLS”), and Secure Sockets Layer (“SSL”)) requests. A controller can be used to process URL requests.

In various embodiments, the system software app could use various data to attempt to quantify how close the two acquaintances were, such as by analyzing the number and date of encounters between the two parties. An encounter could be a text, email, or phone call. The app could also prioritize the hit list by geographic location (lives by me), or age (their b-day is 6 months from mine), etc. The likelihood of the two parties knowing each other could be revealed to the two parties as an acquaintance score (and/or could provide a specific description of the relationship found, including identification of the various relationship databases and relationships found therein) so that the first party could determine their interest and/or desired to revealing their identity to the other party or acquaintance.

If desired, the various ratings and/or other data/derived data could be grouped by complaint or surgical procedure. The number of certain procedures that the physicians did in the past year could be listed if the app also scheduled all of the surgeon's surgeries as well or if the surgeon or hospital provided the app with a list of their surgical patients. The prospective patient could understand the physician's practice based off the number and type of surgeries the surgeon preformed. The app could include the treatment or procedure that the reviewer had with that physician along with the review itself so a prospective patient could weigh certain reviews over others depending on the prospective patient's concerns. For instance, one physician may be really good at a knee replacement but bad at performing a hip replacement. The reviews for this physician might show that they have 4.9 stars out of 5 from patients who had a knee replacement, but only 2.1 stars from patients that had a hip replacement. A prospective patient that needed a knee replacement may not care if that surgeon was any good at hip replacements.

FIG. 2d depicts an interface on a prospective patient's smart phone, wherein an app resident on the smart phone provides a more detailed or granular view of exemplary physician ratings. The prospective patient could view individual ratings within a specific group or subgroup from the list in FIG. 2c. In various embodiments, the prospective patient or customer could request an appointment or purchase a good or service through the app as well. The prospective patient's or customer's name, email and/or cell phone number could be added to a content marketing campaign, an automated email newsletter, or another digital marketing tool.

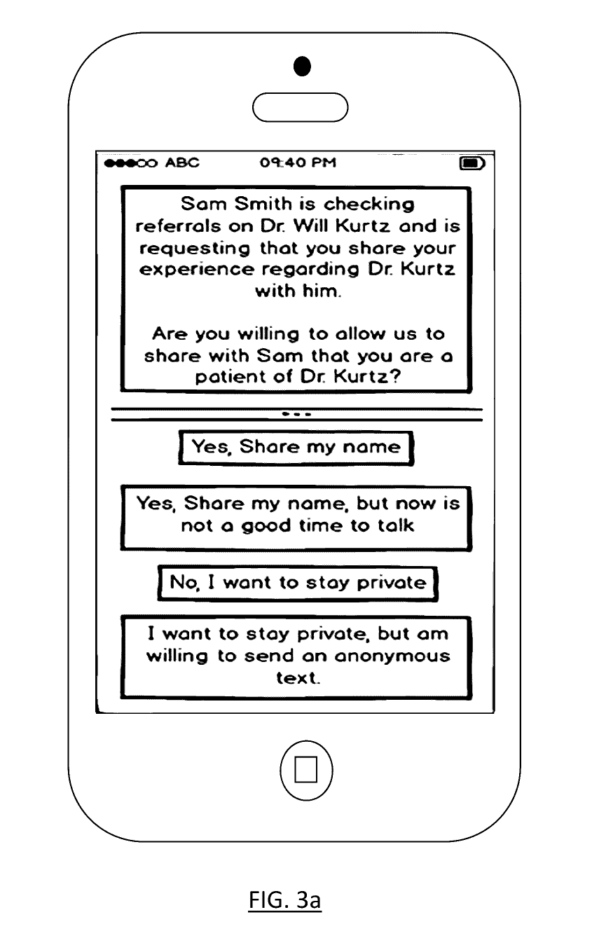

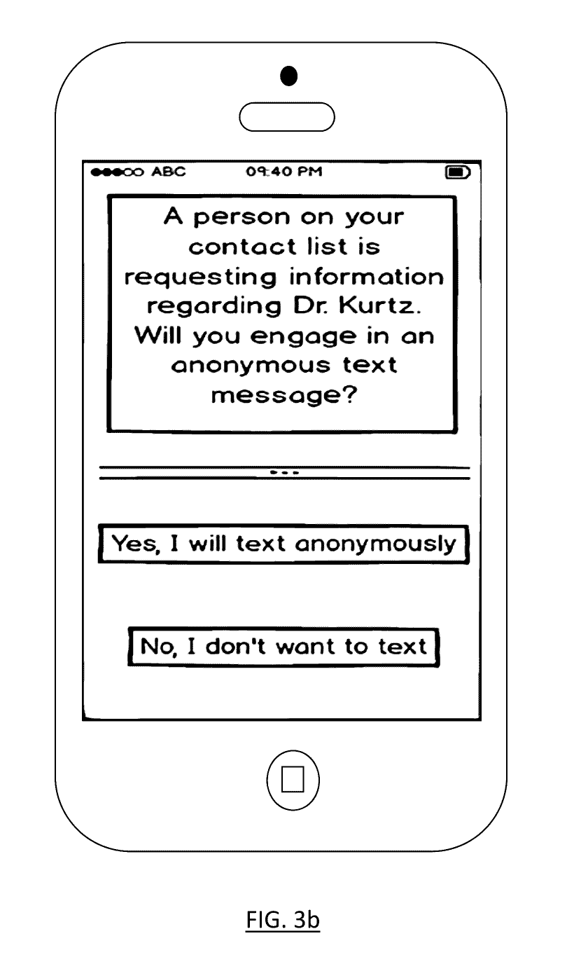

FIGS. 3a and 3b depict an interface on a smart phone, wherein an app resident on the smart phone provides a request for a communications link with the acquaintances regarding a particular physician. In FIG. 3a, the app could then send a message to the “acquaintance” saying, “Sam Smith wants to discuss your experience with Dr. Kurtz. We have not told Mr. Smith your name. Do you want us to reveal your name to Sam Smith, stay private but send an anonymous text message, or stay private and not offer any information?” In FIG. 3b, the prospective patient is requesting to keep their identity private, so the app only asks the “acquaintance” if they want to send an anonymous text message. If the prospective patient is not willing to reveal their identity, it might be unfair to request the acquaintance to reveal their identity first. It is possible to allow the acquaintance to reveal their identity even if the prospective patient did not want to reveal their identity first (not shown).

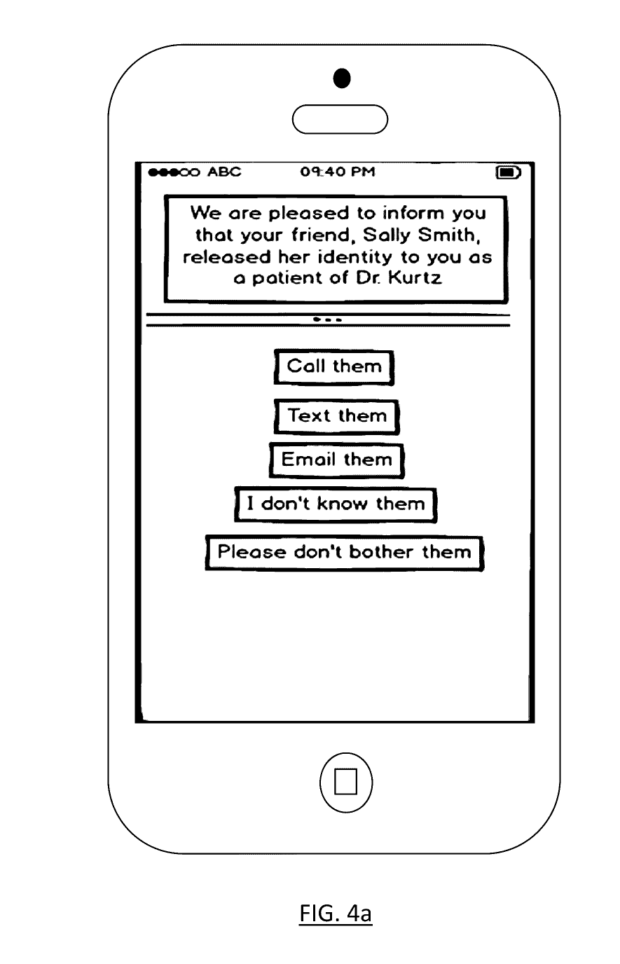

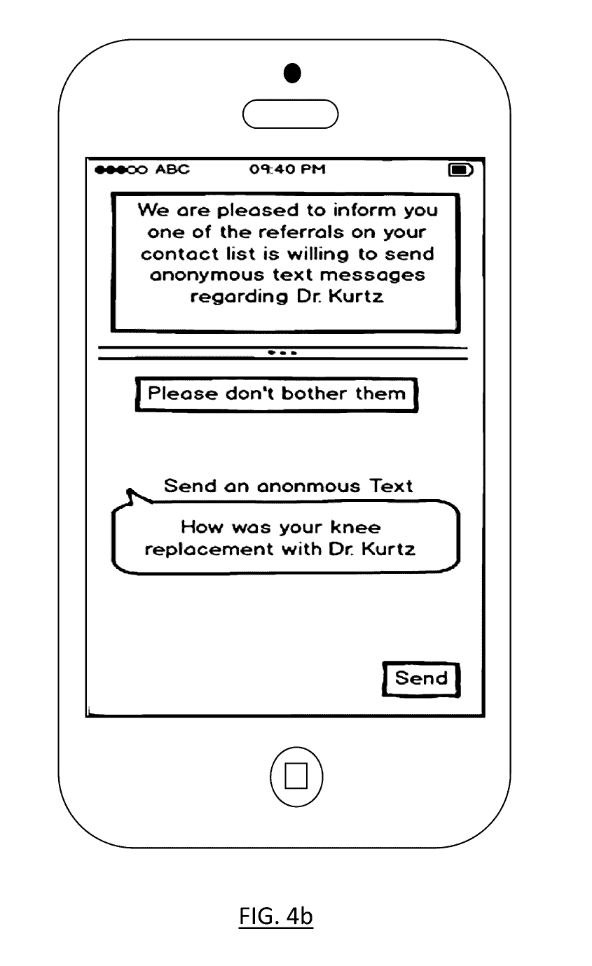

FIGS. 4a and 4b depict an interface on a smart phone, wherein an app resident on the smart phone provides the prospective patient the acquaintance's reply to the identity request from the prospective patient, allowing the prospective patient to communicate with the acquaintance. In FIG. 4a, the acquaintance has revealed their identity to the prospective patient (seen in FIG. 3a) and both parties have agreed to communicate knowing each other's identity either through a phone call, email, text message, or similar type of communication. In FIG. 4b, the prospective patient has the opportunity to communicate anonymously with the acquaintance because the acquaintance has agreed (seen in FIGS. 3a and 3b) to communicate about the physician, but does not want their identity revealed to the prospective patient.

In at least one alternative embodiment, the system application could record customer or patient encounters with a business or healthcare provider (hospitals and/or physicians), but not require the customer or patient to complete a review. The customer or patient encounters could optionally be obtained through the customer relationship management software of the business or the electronic health record of the healthcare provider. When a prospective patient wanted to receive a personalized review on a physician, the app could cross-reference the prospective patient's contact list with all of the patients that had seen that physician. The prospective patient could then reveal their identity to their acquaintance and request that the acquaintance reveal their identity to the prospective patient. Since the acquaintance may not have given a review at or after the good or service was purchased, the acquaintance could also be asked to simply complete a review at that time to be shared with the prospective patient that they knew. This concept is the same idea as the above paragraphs except that patients would not be required to complete a rating of the business, product, goods, services or healthcare provider (hospital and/or physician) after their visit with the provider or purchase of said goods and services. Instead, that patient's rating or review would be completed only when one of their acquaintances requested it.

The various to devices, systems, software and related business methods described herein assist two or more parties having some defined relationship to share their experience regarding a particular provider of particular goods and/or services, such as (but not limited to) healthcare services. By identifying a prospective patient that wants a personalized review on a healthcare provider and another patient that has both already seen this provider and knows the prospective patient, the app allows the prospective patient to request a provider rating from one of their friends that have seen this provider while still protecting their friend's privacy. By controlling the scheduling of the clinic appointments or accessing the electronic health record, the app could capture a review from a vast majority of the patients that see a healthcare provider and avoid the volunteer bias that occurs with other sites. The treatment or procedure preformed by the provider on the reviewer could also be shared along with the review itself so a prospective patient might be able to assign more importance to certain reviews according to the prospective patient's concerns.

By accessing the customer relationship management software or customer database of a business, the app could offer a prospective customer authentic “socially-verified” proof that the business's products, goods or services were valuable and sought after by the prospective customer's peer group.

In various additional embodiments, the features described herein could include advertising and/or revenue generating feature associates with the individual's use of the application on their mobile device. For instance, the user interface could include banner ads or other advertising related to the medical treatment sought by an individual patient. The program could also sell and/or otherwise make available the prospective patient's contact information to other healthcare providers, or other related businesses for the purpose of content marketing, automated email campaigns, or targeted advertising campaigns. Similarly, the system could provide a potential patient (i.e., user) with information regarding potential alternative physicians as part of the referral, such as where the requested physician has low referral ratings and other nearby or similar physicians have higher referral ratings. Alternatively, the system could include a blinded or partially-blinded “physician search” feature which identifies potential physicians using data regarding the potential healthcare treatment (from the prospective patient) along with social networking relationship data to identify potential physicians who previously provided services to relationship linked individuals, and suggesting one or more of such physicians to the prospective patient in the manner described herein. In other words, the prospective patient could select a physician and then locate relationship linked individuals who had seen that physician or the prospective patient could select a procedure and then locate relationship linked individuals who had had that procedure preformed.

### INCORPORATION BY REFERENCE

The entire disclosure of each of the publications, patent documents, and other references referred to herein is incorporated herein by reference in its entirety for all purposes to the same extent as if each individual source were individually denoted as being incorporated by reference.

### EQUIVALENTS

The invention may be embodied in other specific forms without departing from the spirit or essential characteristics thereof. The foregoing embodiments are therefore to be considered in all respects illustrative rather than limiting on the invention described herein. Scope of the invention is thus intended to include all changes that come within the meaning and range of equivalency of the descriptions provided herein.

Many of the aspects and advantages of the present invention may be more clearly understood and appreciated by reference to the accompanying drawings. The accompanying drawings are incorporated herein and form a part of the specification, illustrating embodiments of the present invention and together with the description, disclose the principles of the invention.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the disclosure herein.

The services rendered herein are described in the context of improving the actual and/or perceived reliability of ratings program for medical providers. However, it should be understood that similar systems and methods could be utilized for other industries, including rating restaurants, general contractors, dentist, plumbers, handy men, household cleaning agencies, software services, cloud based services, hotel reviews, vacation rental reviews and other service oriented industries.

What is claimed is:

1. A method of coordinating the transfer of a past or future review of a product or service between a data server and one or more client devices over a data network, the method comprising;
receiving a plurality of information packets regarding a plurality of purchases of a product or service over said data network for storage in a past customer database on the data server, wherein each of said information packets contains information identifying an individual customer with or without a customer review of the product or service and at least one member of a review group consisting of an individual business, an individual product, and individual service provider and an individual service;
receiving an information request over said data network from a prospective customer using the one or more client devices, the information request identifying the prospective customer and at least one member of a proposed review group consisting of a prospective product, a prospective service, a prospective business and a prospective service provider;
utilizing said information request to access one or more third-party databases containing social networking relationship data relating to said prospective customer, and creating a social network map to identify at least one individual customer in said past customer database that is related on said social networking map to said prospective customer;
comparing the at least one member of the review group for the identified past customer to the at least one member of the proposed review group for the prospective customer to identify one or more matching review group members, and creating a matching review group member list;
delivering the matching review group member list to the one or more client devices for display to the past and/or prospective customer;
sharing any previously recorded customer reviews regarding the matching review group member list from the past customer with the prospective customer and/or obtaining a new customer review regarding the matching review group member list from the past customer and sharing the new review with the prospective customer.

2. The method of claim 1, further comprising the step of obtaining permission from the prospective customer to disclose the identity of the prospective customer and one or more matching review group members to the past customer.

3. The method of claim 1, further comprising the step of obtaining permission from the past customer to disclose the identity of the past customer and one or more matching review group members to the prospective customer.

4. The method of claim 1, wherein the prospective customer is a medical patient.

5. The method of claim 1, wherein the prospective customer is a traveler.

6. The method of claim 1, wherein the prospective customer is a restaurant diner.

7. The method of claim 1, wherein the prospective customer is a user of a software program.

8. The method of claim 1, wherein the prospective service is a surgical procedure.

9. The method of claim 1, wherein the prospective product is a medical product.

10. A method of coordinating the delivery of transferable healthcare provider review information between a provider server and one or more client devices over a data network, the method comprising:
receiving healthcare provider review information over said data network for storage in a database, wherein said healthcare provider review information includes but is not limited to the information of an individual past patient, an individual healthcare provider and/or a medical procedure;
receiving an information request over said data network from a prospective patient using the one or more client devices, the information request identifying the prospective patient and at least one of a prospective healthcare providers and/or a prospective medical procedure;
utilizing said information request to access one or more third-party databases containing social networking relationship data relating to said prospective patient and/or the contact list of said prospective patient's electronic device, and mapping said social networking relationship data to identify one or more of said individual past patients having a matching relationship to the prospective patient;
utilizing said information request and said identified matching relationship to generate a list of relevant healthcare provider review information; and
delivering the list of relevant healthcare provider review information to the one or more client devices for display to the prospective patient.

11. The method of claim 10, further comprising a step of requesting and receiving disclosure authorization from the individual patient before the step of delivering the list of relevant healthcare provider review information to the one or more client devices for display to the prospective patient.

12. A system for improving the reliability of customer review information, comprising:
a review database module comprising a plurality of past customer purchases or interactions with a business, each of the plurality of customer purchases linked to an individual customer identifier;
a prospective customer request module, which receives an information request from a prospective customer, the information request containing a prospective customer identifier and at least one of a prospective product or service and/or a prospective business identifier;
a relationship identification module, which accesses one or more third-party social networking website databases and/or the contact list of a smart phone device and utilizes the prospective customer identifier and the plurality of past customer identifiers possibly linked to the plurality of customer reviews to identify one or more pre-existing matching relationships between the prospective customer identifier and the plurality of past customer patient identifiers; and
an optional review delivery module that generates a matching review list of the available customer reviews corresponding to the matching relationships, obtains new customer reviews corresponding to the matching relationships and adds them to the matching review list, and delivers the matching review list to the prospective customer for review; and
a customer communication module that obtains permission from both the prospective and past customer to release their information to the other party and facilitate communication between the two parties through a phone call, text message, email or other digital communication.

13. The method of claim 12, wherein the prospective customer is a medical patient.

14. The method of claim 12, wherein the prospective customer is a traveler.

15. The method of claim 12, wherein the prospective customer is a restaurant diner.

16. The method of claim 12, wherein the prospective customer is a user of a software program.

17. The method of claim 12, wherein the prospective product or service is a surgical procedure.

18. The method of claim 12, wherein the prospective product or service is a medical product.

19. The method of claim 12, wherein the business is a hospital.

20. The method of claim 12, wherein the business is a physician.
